(19) United States
(12) Patent Application Publication
(10) Pub. No.: US 2025/0033211 A1
(43) Pub. Date: Jan. 30, 2025

(54) ROBOTIC PATH PLANNING

(71) Applicant: Worcester Polytechnic Institute, Worcester, MA (US)

(72) Inventors: Sean McGovern, Worcester, MA (US); Jing Xiao, Shrewsbury, MA (US)

(21) Appl. No.: 18/787,513

(22) Filed: Jul. 29, 2024

Related U.S. Application Data
(60) Provisional application No. 63/529,190, filed on Jul. 27, 2023.

(51) Int. Cl. B25J 9/16; B25J 9/02

(52) U.S. Cl. CPC B25J 9/1664; B25J 9/023

(57) ABSTRACT

A generalized approach and methodology for addressing surface traversal and coverage of a 3 Dimensional (3-D) object receives a 3-D wireframe or similar Cartesian based representation, converts the 3-D representation to a u,v system or mapping. Often employed for texture mapping, u.v grid systems define a two dimensional form of an object, often referred to as “unfolding” of an object. Configurations herein define a u.v grid system directly on the 3-D object for computing a coverage path, typically an aggregation of raster passes to traverse an entire 3-D surface. From a robotic manipulator, a 3D freeform surface, and task constraints, the approach determines whether there exists a feasible continuous motion plan to cover the surface, and if so, produces a uniform coverage path that best satisfies task constraints resulting from the physical object and robot kinematics.

### RELATED APPLICATIONS

This patent application claims the benefit under 35 U.S.C. § 119 (e) of U.S. Provisional Patent App. No. 63/529,190, filed Jul. 27, 2023, entitled “ROBOTIC PATH PLANNING,” incorporated herein by reference in entirety.

### STATEMENT OF FEDERALLY SPONSORED RESEARCH AND DEVELOPMENT

This invention was developed with U.S. Government support under contract No. W911NF1920108, awarded by the Army Research Lab, and under NRT grant 1922761, awarded by the NSF (National Science Foundation).

### BACKGROUND

There are many industrial robotic applications which require a robot manipulator's end-effector to fully cover a 3D surface region in a constrained motion. Constrained surface coverage in this context is focused on placing commonly used coverage patterns (such as raster, spiral, or dualspiral) onto the surface for the manipulator to follow. The manipulator must continuously satisfy surface task constraints imposed on the end-effector while maintaining manipulator joint constraints. While there is substantial research for coverage on planar surfaces, methods for constrained coverage of 3D (spatial) surfaces are limited to certain (parametric or spline) surfaces.

### SUMMARY

A generalized approach and methodology for addressing surface traversal and coverage of a 3 Dimensional (3-D) object receives a 3-D wireframe or similar Cartesian based representation, and converts the 3-D representation to a u,v system or mapping.

Often employed for texture mapping, u.v grid systems define a two dimensional form of an object, often referred to as “unfolding” of an object. Configurations herein define a u.v grid system directly on the 3-D object for computing a coverage path, typically an aggregation of raster passes to traverse an entire 3-D surface. From a robotic manipulator, a 3D freeform surface, and task constraints, the approach determines whether there exists a feasible continuous motion plan to cover the surface, and if so, produces a uniform coverage path that best satisfies task constraints resulting from the physical object and robot kinematics.

Configurations herein are based, in part, on the observation that surface modeling and analysis of 3-D objects is often undertaken for tasks such as surface textures in computer graphics, as well as practical uses in industrial tasks such as painting, spray coating, abrasive blasting, polishing, shotcreting and others. Unfortunately, conventional approaches to surface analysis and mapping often partition an object surface into a series or set of surfaces, typically based on mathematical representations of the different partitions. UV mapping may be employed, which is the 3D modeling process of projecting a 3D model's surface to a 2D image, often for texture mapping. This is computationally intensive and requires manual segregation of the partitions for individual treatment. Accordingly, configurations herein substantially overcome the shortcomings of conventional approaches by defining a uv system directly on the free form space, often defined by a point cloud or 3-D cartesian representation.

In further detail, in a robotic environment having a task object represented by a 3D surface, a method for planning a coverage path includes receiving a representation of the task object in a 3-dimensional coordinate system, where the task object is defined by a surface, and evaluating the task object for determining a feasibility of a coverage pattern, such that the coverage pattern defines a continuous traversal of the surface. From the uv representation, an application computes a coverage path for traversing the surface according to the coverage pattern, where the coverage path is defined by the uv coordinate set representing the surface. The singular path results from computing a uv grid directly on the surface from the representation of the task object, where the representation is a 3 dimensional free form surface and the uv grid defining the surface of the task object. No constituent faces or sides of the object need be partitioned, or “unwrapped.”

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of an imaging environment suitable for use with configurations herein;

FIGS. 2A-2B show examples of discretization in the environment of FIG. 1;

FIGS. 3A-3C show examples of surface types for generating the uv grid based representation from the 3D (3 Dimensional) input representation;

FIGS. 4A-4B show examples of constraints in defining the robotically traversed uv grid space;

FIG. 5 shows joint task space constraints applied to the uv grid space;

FIGS. 6A-6B show raster scan paths for providing the coverage path over the entire object;

FIGS. 7A-7D shows a polygon mesh rendering of the received input representation of the task object;

FIGS. 8A-8D show an initial curve for the uv grid space representation of the respective objects of FIGS. 7A-7D; and

FIGS. 9A-9D show a coverage path computed on the uv grid for the respective objects from FIGS. 7A-7D and 8A-8D.

### DETAILED DESCRIPTION

A robotically driven surface coverage exhibits a path planning problem on 3D surfaces. Such surface coverage planning may be invoked for many industrial applications, such as painting, spray coating, abrasive blasting, polishing, shotcreting, laser ablation and others. Configurations herein provide a principled and general approach that includes an automatic robotic system to find feasible robotic end-effector paths for covering a 3D freeform surface, based on provided key parameters related to the specific task. Therefore, the approach enables a human worker who only has the domain knowledge of a specific coverage task to operate the general and automatic robotic system effectively for completing the task.

The use of robots for surface coverage applications is common in many industries including those of automobiles, furniture, aircraft, construction, agricultural, and appliances. Industrial manipulator coverage applications (such as spray coating/painting, abrasive blasting, polishing, shotcrete, laser ablation, etc.) require a manipulator's end-effector to traverse the entire surface once while satisfying task criteria in terms of application thickness, cycle time, and material waste. The quality of production is usually determined by manipulator tool coverage uniformity and how it was applied on the surface (i.e. angle of approach, surface offset, etc.). Manual generation of a continuous and even coverage tool path on a 3D freeform surface is complex, time consuming, ad hoc, and difficult to optimize. Conventional approaches generally expect a human operator having substantial knowledge of robotic manipulation. With the need for rapid and efficient production and repairs in related industries, it would be beneficial to enable automated and optimal robotic coverage on 3D freeform surfaces, as defined herein.

In a conventional approach to surface mapping and coverage, uv coordinates are typically applied to each individual face of a task object. This means a shared spatial vertex position can have different UV coordinates for each of its triangles, so adjacent triangles can be cut apart and positioned on different areas of the texture map. The resulting decomposition of multiple surface regions complicates processing and prevents a single coverage path from being defined across the entire surface, a property referred to as singularity, discussed further below. Such a conventional uv mapping process at its simplest requires three steps: unwrapping the mesh, creating the texture, and applying the texture to a respective face of polygon. In the claimed approach, in contrast, no such unwrapping needs to be performed, and no disparate individual treatment of multiple faces is needed.

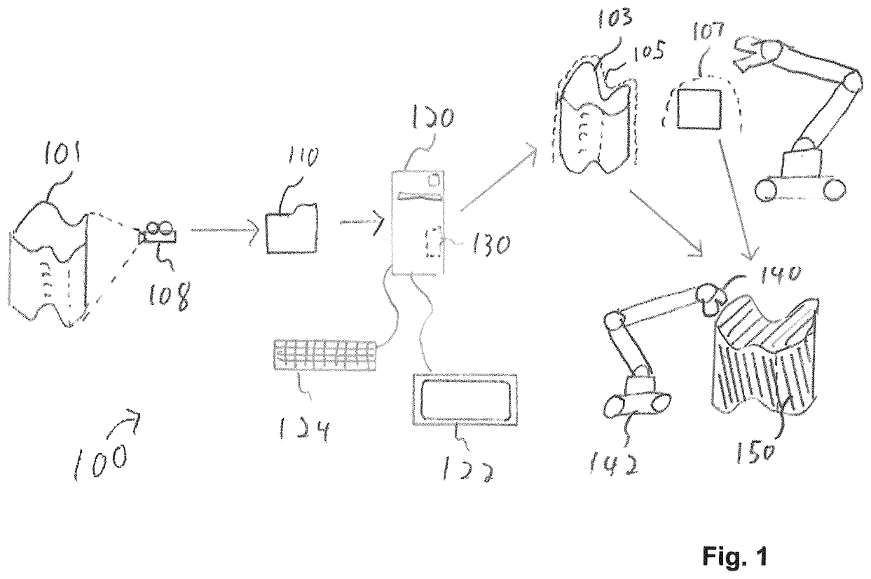

FIG. 1 is a context diagram of an imaging environment suitable for use with configurations herein. In an imaging or industrial environment 100, a task object 101 incurs a need for a surface analysis task, process or treatment. A 3-D representation, such as a point cloud, wireframe or other approach results from an imaging analyzer 108, such as a camera, scanner or other suitable input device. One common representation is to receive the task object as a wireframe representation of triangles defined by nodes and vertices in a 3 dimensional Cartesian system. The 3-D representation 110, typically defined in a Cartesian-based system, is received by a server 120 having a path coverage and planning application 130 (application). Appropriate peripherals and UI (user interface) devices, such as rendering screens 122 and keyboards 124, may also be invoked. Within the application 130, the 3-D cartesian representation 110 of the task object 101 is analyzed, and a uv grid or system 105 defined directly on the surface 103 of the task object. Feasibility analysis considers both the object space expressing the spatial limits of the object, typically within the uv grid 105, and robot space 107 defining constraints on robotic movement by a robot 142. If a coverage pattern can be defined on the surface, meaning a robotic actuator 140 can access the entire surface 103, then the application 130 computes a continuous coverage path 150 for traversing the surface 103, typically as a set of interconnected raster segments over the surface 103.

Configurations herein address the following fundamental problem: given a manipulator, a 3D freeform surface, and task constraints, how to enable a human worker, who is a task expert but not trained in robotics, to use automatic algorithms to determine the feasibility for the end-effector to traverse the entire surface continuously while maintaining the task and manipulator constraints, and if it is feasible, produce an evenly spaced, continuous coverage path that best satisfies task constraints.

In a robotic environment as in FIG. 1 having the task object 101 represented by a 3D surface, the disclosed method for planning a coverage path includes receiving the representation 110 of the task object in a 3-dimensional coordinate system, where the task object 101 is defined by a surface around the object. The application 130 generates a uv grid 105 on the 3-D freeform surfaces of the task object 101. The application 130 then performs feasibility checking of the 3-D freeform surfaces covered by the uv grid 105. This includes evaluating the task object 101 for determining a feasibility of a coverage pattern 150, such that the coverage pattern defines a continuous traversal of the surface 103. Upon determining feasibility, the application 130 computes placement of a coverage pattern 150 on the uv grid 105 of the 3-D freeform surface 103 and a mapping of the pattern from the uv grid to the Cartesian space of the object 101. The application 130 then computes a feasible coverage path of the manipulator 140 to follow the coverage pattern. This generally implies computing the coverage path 150 for traversing the surface according to the coverage pattern, such that the coverage path 150 is defined by a uv coordinate set representing the surface 103. The above steps thus consist of four stages: (1) generating a uv space and grid on a 3D freeform surface, (2) constrained coverage feasibility checking, (3) putting a coverage pattern on a freeform surface, and (4) coverage path singularity detection and avoidance.

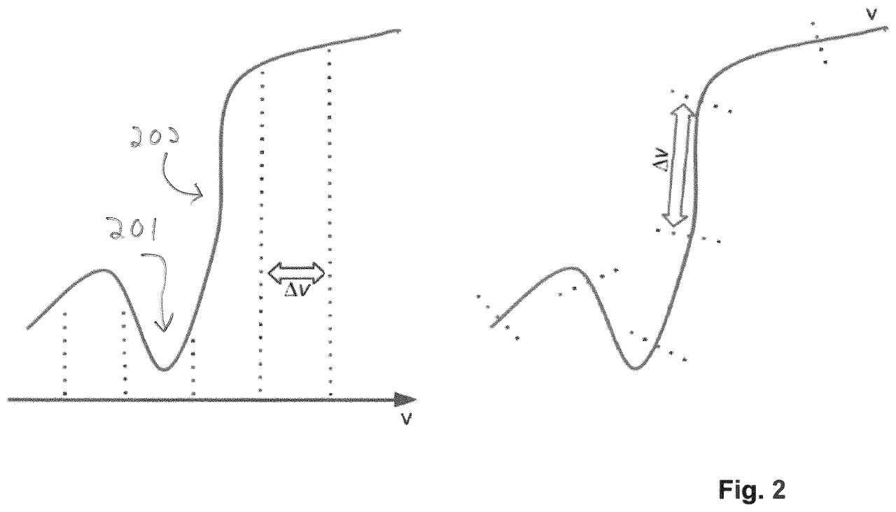

Generation of the uv grid 105 involves discretization of the Cartesian points or references defining the surface. FIGS. 2A-2B show examples of discretization in the environment of FIG. 1. Referring to FIGS. 1-2B, conventional approaches to coverage path planning on 3D surfaces tend to rely on Cartesian axes as references for coverage pattern spacing. This can result in uneven discretization of the surface, as illustrated in FIG. 1A. By defining the uv space directly on the freeform surface 103 and discretize it to generate a grid of evenly spaced uv cells. this allows uv parameters be curve length parameters along the surface to achieve even spacing, shown between the “ . . . ” segments in FIG. 2B of the freeform surface along a curve, avoiding local minimums 201 or maximums/inflections 202 that can elude cartesian axis spacing. In other words, the resulting coverage path 150 defines an even discretization of points on the uv grid 105 defining the surface.

Coverage feasibility refers to the manipulator's end effector 140 path satisfying continuously both task and manipulator constraints, which depends on manipulator kinematics and surface parameters, while covering an entire surface. Violation of manipulator constraints causes either no solution for inverse kinematics or singularity configurations that prevent the end-effector to move smoothly along the surface.

In general, the position and orientation constraints on the manipulator or its end-effector are either equality or inequality constraints: Equality constraints on application surface coverage include end-effector offset and uniform thickness, which in turn constrain the end-effector position and velocity; inequality constraints include limits on tool angle to surface, which constrain the end-effector orientation, manipulator joint limits, which constrain the joint positions, and velocity change limits, which constrain both the end effector and manipulator trajectories. To avoid expensive inverse kinematic calculations, the disclosed approach searches for the existence of a feasible end-effector path between uv-cells in the manipulator's joint space. Feasibility checking regarding freeform surfaces includes deriving constraints on 3-D polygonal meshes and improving the end-effector joint space search to be more efficient based on information from the manipulator Jacobian, as described below.

If the feasibility check determines that a feasible continuous coverage path exists for a 3D freeform surface given the task and manipulator constraints, a coverage pattern is placed on the uv grid and mapped to the Cartesian space to facilitate coverage motion determination. Coverage patterns such as raster scans or Archimedean spirals are generally used for constrained surface coverage applications due to their constant separation between adjacent turns, thus resulting in uniform coverage.

Finally, given that a feasible coverage path exists (from feasibility checking) and a coverage pattern, the application 130 generates the end-effector's coverage path that satisfies the position and orientation constraints. The initial end-effector position can be determined by applying an offset d from the surface (as required by the position task constraint), and the initial endeffector orientation can be determined as the optimal tool angle to surface (usually the surface normal, as required by the orientation constraint). An initial end-effector path can be created in terms of the sequence of end-effector positions and orientations corresponding to the centers of uv-cells along the coverage pattern. However, such an initial path may not be feasible, and our system finds a feasible path by detecting singularities along the initial path and modifying the end-effector configurations mainly through altering the end-effector orientations to avoid singularities.

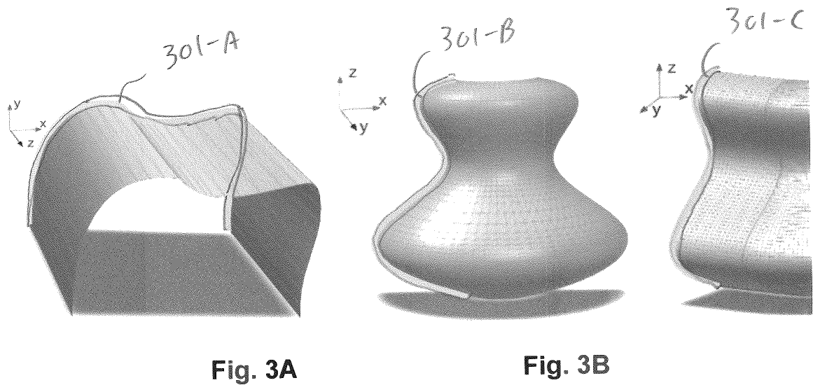

FIGS. 3A-3C show examples of surface types for generating the uv grid based representation from the 3D (3 Dimensional) input representation. Referring to FIGS. 1-3C, the application 130 computes a uv grid on the surface 103 from the representation of the task object 101. In a typical configuration, the representation is a 3 dimensional free form surface with the uv grid 105 defining the surface of the task object.

Configurations herein consider a 3D polygon mesh representation of a physical freeform surface, S. The physical surface of an object can be scanned using modern 3D scanning technology and approximated as a 3D polygon mesh, which is the most common way to represent a general surface when there is no other more precise model. Additionally, S must fit within the workspace of a robotic arm to allow the end-effector to cover the surface. A large surface may be segmented to small S ′s using a hierarchical approach.

The application 130 computes the uv grid by receiving the representation as a 3-dimensional polygon mesh defining a non-intersecting free form surface, as in FIGS. 3A-3C. The application locates an axis and a curve on the free form surface, and performs one or more of:
i: computing a surface of translation based on a translation of the curve along the axis,
ii: computing a surface of rotation based on a rotation around the axis, or
iii: computing a surface of translation and rotation from the curve such that rotations along the surface are parallel to the axis and translations of the curve are on a plane normal to the axis.

The application 130 defines and considers these types of general 3D freeform surfaces that can be generated from some transformation of a planar, non self-intersecting freeform curve C, along or about some axis, called [symbol] in FIGS. 3A-3C. In the 3D freeform surface types (embedded polygon meshes) of FIGS. 3A-3C, Curve C₀ 301-A . . . 301-C, respectively, for each definition is denoted:
Surface of translation (SoT): translation of C, along [symbol] , (Freeform surface of translation along the z axis; FIG. 3A).
Surface of rotation (SoR): rotation of C, about [symbol] (Freeform surface of rotation about the z axis; FIG. 3B).
Surface of translation and rotation (SoTR): combinations of SoTs and SoRs from a single C, such that all rotation axes of C are parallel to [symbol] and all translation axes of C are on a plane normal to [symbol] (Freeform surface of translation, on the xy plane, and rotation about axis parallel to the z axis; FIG. 3C).

The curve C can be known or approximated or computed from input. It should be noted that the above surface types share an important property that curve C is theoretically the same along each axis of translation or about each axis of rotation. For a SoTR, the surface can be a continuous combination of translations and rotations of curve C, which may occur simultaneously, as long as the rotation axis remains in the same direction, and the translation axis is always orthogonal to the rotation axis. The above surfaces can capture many surfaces in the real world.

An interface for the disclosed approach provides a human worker, who is a task-domain expert but not a robotics expert, with a visual and numerical representation of the spatial and orientation arrangement between the surface S and the manipulator. The application 130 denotes S_{f} as the coordinate frame of S. The human worker may initially adjust the position and orientation of S_{f} with respect to the manipulator base (world frame), thus changing the arrangement between S and the manipulator. Additionally, S_{f} may be positioned by the human worker with respect to surface mesh vertices to facilitate automatic generation of the uv grid.

To enable automatic uv grid generation, the human worker first determines the surface S as one of the three types defined. Then, they align the z-axis of the surface frame S_{f} with axis [symbol] , and our underlying automatic system helps the human worker to verify if S_{f} is placed accurately by showing the resulting curve C 301-A . . . 301-C (301 generally). FIG. 3(b) shows an inaccurate placement of S_{f}, where the curve C 301-B is too short, and FIG. 3(c) shows the accurate placement of S_{f} 301-C.

The application 130 generates uv space for the three types of freeform surfaces, surface of translation (SoT), surface of rotation (SoR), and surface of translation and rotation (SoTR), in turn. For each type of surface, the surface coordinate frame S_{f} is set such that the z axis is along the axis [symbol] , as shown in FIGS. 3A-3C. The v coordinates are defined along the curve C, recalling that the curve C remains the same theoretically during translation and rotation to form the surface. The starting v coordinate is at one end point of C. The u coordinates are defined along curves perpendicular to C. The following describes how to obtain the [u, v] coordinates for all vertices of the triangle mesh for each type of surface.

For a uv space for SoT, let C₀ be the curve C on the xy plane at the beginning of translation (obtained by the human worker) with z₀.

The approach sweeps (i.e., translates) a plane perpendicular to the z axis from z₀ to increase z value, starting from the xy plane. The sweeping pauses at every triangle vertex encountered and records the z value as zᵢ, i=1, . . . , m. The approach then obtains the corresponding curve Cᵢ as the intersection of the xy plane with surface S at zᵢ.

Let (x_{i,j}, y_{i,j}, z_{i,j}) be the coordinates of the j th triangle vertex on the curve Cᵢ,j=0, . . . , nᵢ. These points share the same u coordinate:

$${u}_{i , j} = {z}_{i} \qquad ( 1 )$$

For j=1, . . . , nᵢ, let Δx_{i,j}=x_{i,j}−x_{i,j-1} and Δy_{i,j}=y_{i,j}−y_{i,j-1}. We can compute v_{i,j} by initializing v_{i,0}=0 and:

$${v}_{i , j} = {v}_{i , j - 1} + \sqrt{Δ {x}_{i , j}^{2} + Δ {y}_{i , j}^{2}} , j = 1 , … , {n}_{i} \qquad ( 2 )$$

$$Thus ,$$

$${v}_{i , j} = {\sum }_{k = 1}^{j} \sqrt{Δ {x}_{i , k}^{2} + Δ {y}_{i , k}^{2}} \qquad ( 3 )$$

For a uv space for SoR:

Denote the angle of rotation as ¢ and radius (i.e. vertex distance from axis of rotation) as r(z), which is an unknown function of z due to the freeform curve C. Let Co indicate the curve C on the plane of ϕ=ϕ₀.

Now, by increasing ϕ and rotating the corresponding plane (which goes through the z axis), our method pauses the rotating plane at every triangle vertex encountered and records the ϕ value as ϕᵢ, i=1, . . . , n. Our algorithm then obtains the corresponding curve Cᵢ as the intersection of the plane with surface S at ϕᵢ.

Let (x_{i,j}, y_{i,j}, zⱼ) be the local coordinates of the j th triangle vertex on the curve Cᵢ with Cᵢ, for j=0, . . . , nᵢ. Compute its u coordinate as:

$${u}_{i , j} = r ( {z}_{j} ) \cdot {ϕ}_{i} \qquad ( 4 )$$

For j=1, . . . , nᵢ, let Δzⱼ=zⱼ−zⱼ₋₁ and Δrⱼ=rⱼ−rⱼ₋₁. We can compute v_{i,j} by initializing v_{i,0}=0:

$${v}_{i , j} = {v}_{i , j - 1} + \sqrt{Δ {z}_{j}^{2} + Δ {r}_{j}^{2}} , j = 1 , … , {n}_{i} \qquad ( 5 )$$

$$Thus ,$$

$${v}_{i , j} = {\sum }_{k = 1}^{j} \sqrt{Δ {z}_{j}^{2} + Δ {r}_{j}^{2}} \qquad ( 6 )$$

For uv Space for SoTR, in this case, all rotation axes are parallel to the z-axis, and all translation axes are orthogonal to the z-axis. Let Co be on plane P that also includes the z axis.

The SoTR surface and the xy plane intersects at curve U, which intersects Co at point p₀. The approach sweeps the plane [symbol] along U while maintaining it perpendicular to U at each point, and the sweeping pauses at every triangle vertex encountered on S by [symbol] and records the Cartesian position of the intersection point with U. Let pᵢ indicate the i th intersection point between the swept [symbol] and U, and let the corresponding C curve be Cᵢ, for i=1, . . . , m.

Let (x_{i,j}, y_{i,j}, z_{i,j}) be the coordinates of the j th triangle vertex on the curve Cᵢ, for j=0, . . . , nᵢ. For i=1, . . . , m, let Δⱼx_{i,j}=x_{i,j}−x_{i-1,j} and Δⱼy_{i,j}=y_{i-1,j}−y_{i,j}. By initializing u_{0,j}=0, we can compute the u coordinate of the point as:

$${u}_{i , j} = {u}_{i - 1 , j} + \sqrt{{Δ}_{j} {x}_{i}^{2} + {Δ}_{j} {y}_{i}^{2}} , i = 1 , … , m \qquad ( 7 )$$

$$Thus ,$$

$${u}_{i , j} = {\sum }_{k = 1}^{i} \sqrt{{Δ}_{j} {x}_{k}^{2} + {Δ}_{j} {y}_{k}^{2}} \qquad ( 8 )$$

Now, Let Δᵢx_{i,j}=x_{i,j}−x_{i,j-1}, Δᵢy_{i,j}=y_{i,j}−y_{i,j-1}, Δᵢz_{i,j}=z_{i,j}−z_{i,j-1}, j=1, . . . , nᵢ. By initializing v_{i,0}=0,
we can compute the v coordinate of the point as:

$${v}_{i , j} = {v}_{i , j - 1} + \sqrt{{Δ}_{i} {x}_{i , j}^{2} + {Δ}_{i} {y}_{i , j}^{2} + {Δ}_{i} {z}_{i , j}^{2}} , j = 1 … , {n}_{i} \qquad ( 9 )$$

$$Thus ,$$

$${v}_{i , j} = {\sum }_{k = 1}^{j} \sqrt{{Δ}_{i} {x}_{i , k}^{2} + {Δ}_{i} {y}_{i , k}^{2} + {Δ}_{i} {z}_{i , k}^{2}} \qquad ( 10 )$$

As mentioned above, one of the advantages of the disclosed approach is discretization of the uv space. For every triangle [symbol] on the surface S, its vertex with position τᵢ=[τᵢₓ, τ_{iy}, τ_{iz}]^{T}, i=1,2,3, now has uv coordinates [τᵢᵤ, τᵢᵥ]^{T}. Note that the uv coordinates at each of those points are real numbers as computed above, even though those discrete points are indexed by integers.

Additionally, for any other point s inside the triangle, its coordinates of either Cartesian space or uv space can be found based on its distance to one of the triangle vertices. Let pₛ indicates point s ′s position in the Cartesian space, point s ′s barycentric coordinates, wᵢ, can be found from the following equations:

$${p}_{s} = {Σ}_{i} {w}_{i} {τ}_{i} , 0 \leq {w}_{i} \leq 1 , {Σ}_{l} {w}_{i} = 1 \qquad ( 11 )$$

From the barycentric coordinates, the point s ′s uv-space coordinates [u, v] can be determined. In general, the Barycentric coordinates wᵢ ′s can be used to find either Cartesian or uv-space coordinates of a point inside a triangle from the corresponding vertex coordinates of the triangle.

To discretize the uv space into a grid with uniform cells, let Δu and Δv be the desired dimensions of an uv-cell. We denote a uv-cell with the cell center coordinates [uⱼ, vₖ], where j and k are integer indices for the discretization, even though the uv-space coordinates uⱼ and vₖ are real numbers from the original continuous space.

To perform feasibility checking, it is important to first introduce a general position and orientation constraint formulation and next present an improved joint-space feasibility checking algorithm, which in turn determines end-effector coverage path feasibility. In this step, determination of the feasibility further includes identifying task based on kinematics of a robot for movement along an entirety of the uv coordinate system representing the surface of the task object, meaning can the robot physically traverse the surface 103 through proper manipulation within the range of movement of the robotic arms. The process 130 then identifying manipulator constraints indicative of a manipulator coupled to the robot attaining placement within a predetermined offset distance of the surface of the task object, meaning can the end effector (paint sprayer, welding torch, and others) attain a proper orientation with the surface, generally meaning at an appropriate offset and angle.

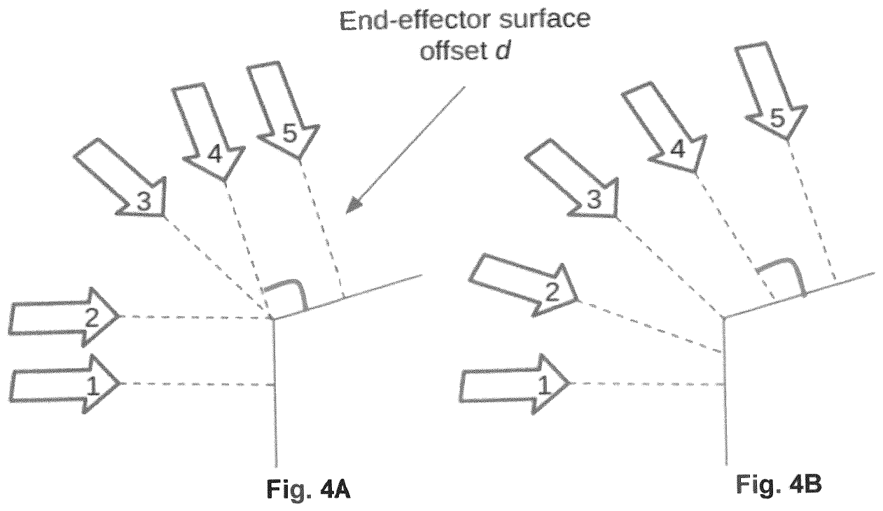

In general, the end-effector's position and orientation task constraints are related, in that the distance constraint from the end-effector position to the surface S should be measured along the end-effector approach vector, which is determined by the end-effector's orientation task constraint. In a particular configuration, the end-effector's position and orientation constraints were introduced independently, which prohibited deviations of the approach vector from the optimal surface normal in order to satisfy the end-effector position constraint (to maintain constant offset) with respect to the surface. As a result, it was difficult to handle transitions around sharp edges and vertices. FIGS. 4A-4B show examples of constraints in defining the robotically traversed uv grid space. Referring to FIGS. 4A-4B, FIG. 4A compares the effects of position and orientation constraints defined independently, which causes large orientation shift around surface edges, and FIG. 4B shows a position constraint defined along the approach vector a, i.e., related to the orientation constraint, which allows for smooth orientation change around surface edges.

In order to achieve smoother transitions around edges and vertices of a 3D freeform surface (in polygonal mesh) during surface traversal, shown in FIG. 4B, it is important to consider interrelated position and orientation task constraints as follows.

We r_{**} denote the end-effector position in Cartesian space with respect to the surface coordinate frame as p and the end-effector approach vector as the unit vector a (along the z axis of the end-effector), such that:

$$a = {[ {r}_{13} , {r}_{23} , {r}_{33} ]}^{T} , \qquad ( 12 )$$

where p′ is from the rotation matrix R of the manipulator end-effector. A task constraint is imposed on the end-effector such that its position must be offset from the surface at a distance d along the approach vector a, satisfying

$$p + d \cdot a = {p}^{′} , \qquad ( 13 )$$

where p′ is the position of a point on the surface S. The approach vector a must also satisfy the orientation constraint:

$$- b \cdot a \leq cos α , \qquad ( 14 )$$

where 0≤α≥ϵ is the allowable approach angle deviation from the surface normal, b.

Let p′ be on the uv-cell [uⱼ, vₖ], which is on a triangle [symbol] of the surface with vertex positions τ₁, τ₂, and τ₃. Using the task constraint of Eq. (13), we have

$$p + d \cdot a = {Σ}_{i} {w}_{i} {τ}_{i} , 0 \leq {w}_{i} \leq 1 , {Σ}_{i} {w}_{i} = 1 , \qquad ( 15 )$$

which expresses the task constraint on the corresponding end-effector position p in terms of τᵢ ′s.

With end-effector position p expressed in terms of the triangle parameters of the uv-cell [uⱼ, vₖ] and the angle α as in equations (13)-(15), we can relate an n-dimensional robotic manipulator's link parameters, l, and joint variables, q, directly to the task constraint equations using forward kinematics to obtain joint space task constraints.

$$f ( l , q ) = c ( {u}_{j} , {v}_{k} , 𝒯 , α ) \qquad ( 16 )$$

The manipulator joint configurations that satisfy the joint space task constraints Eq. (16) form what we call a J manifold. We can discretize the J-manifold into an n dimensional grid, where each cell, called a J-cell, corresponds to a joint configuration q. The distance between two neighboring J-cell joint configurations is dq such that each joint variable's value qᵢ in q is increased or decreased by δq or remains the same to reach its neighboring J-cell. Thus, a given J-cell has 3ⁿ−1 neighboring J-cells. Through forward kinematics a J-cell corresponds to a feasible end-effector configuration, an E-cell with position p and orientation R. We denote the space of all E-cells as the E-manifold.

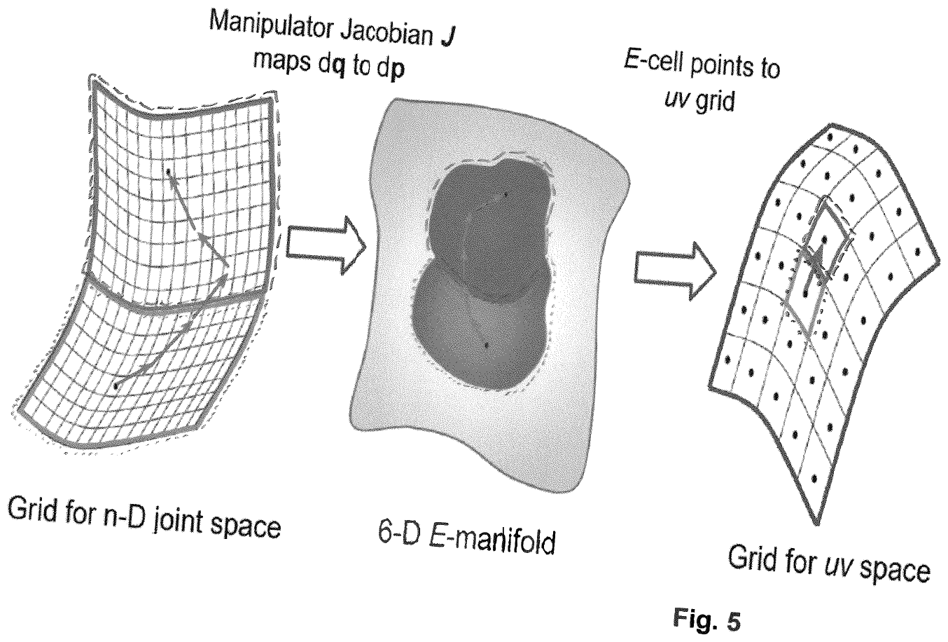

An E-cell with position p maps to a point on the surface with position p′, by Eq. (13), and p′ can be converted to uv space. Note that multiple E-cells with different a (approach) vectors may map to the same surface position p′ or the same uv coordinates. Mappings between the J-manifold, E-manifold, and the uv grid are illustrated in FIG. 5. FIG. 5 shows joint task space constraints applied to the uv grid space. Referring to FIG. 5, the conversion from J-manifold (left), to the E-manifold (center), and then to the uv grid (right) is shown, where. The corresponding regions in each manifold are shown in the same dotted/dashed outlines.

TABLE I
CONTINUITY CHECK ON UV GRID PROCESS

```
Global Neighbors;
Input uv₁ and corresponding jc₁; Initialize Tree T at uv₁;
Initialize graph G containing all uv-cells with no edges;
T , G = TREESEARCH(T , G,jc₁);
if G is a connected component then
  return “∃ feasible path”
else
  return “no feasible path”
end
procedure TREESEARCH(T , G, jc):
From jc get corresponding uv-cell called uv; Neighbors = unvisited neighbor uv-cells of
uv; repeat:
Randomly generate none-zero dq;
call CONT with jc, dq, which returns continuity between uv and a neighbor uv_{N} and the
corresponding J -cell jc_{N} ;
Neighbors =Neighbors − {uv_{N} };
if continuity then
  Add edge between uv and uv_{N} if uv_{N} is not in
  G;
  if uv_{N} is not in T then
    Add uv_{N} as child to uv in T ;
    T, G = TREESEARCH(T , G, jc_{N} )
  end
end
until Neighbors = ∅;
return T , G;
```

The coverage feasibility checking process of Table I explores the uv grid, using a tree search, reaching every uv-cell once. Starting from an initial uv-cell, uv₁, which inversely maps to a J-cell, jc₁, the algorithm stores neighbor uv-cells in Neighbors and randomly generates a none-zero dq by randomly assigning a value from {−δq, 0, δq} for each joint. It calls the process of Table II to search the J-manifold moving through neighboring J-cells, until a corresponding E-cell is reached, which maps inside a neighboring uv-cell (i.e. the uv-cell with its center closest to the corresponding uv point of that E-cell), and establish that there is a neighboring feasibility continuity of the manipulator to cover the two uv cells.

TABLE II
CONTINUITY CHECK ON J-MANIFOLD BETWEEN
NEIGHBORING UV-CELLS PROCESS

```
procedure CONT(jc, dq):
repeat:
From dq find the neighbor jc′ of jc;
if jc′ satisfies joint-space task constraints and joint limits then
  E-cell ec is obtained from jc via forward
  kinematics;
  dx = J(q) · dq;
  From ec and dx, obtain next E-cell ec_{N} ;
  By mapping ec and ec_{N} to the uv space, get the
  direction from uv to a neighbor uv_{N} ;
  if uv_{N} ∈ Neighbors then
    if uv_{N} is reached then
      continuity = true; jc_{N} = jc′;
      return continuity, uv_{N} , and jc_{N} ;
    end
    call CONT(jc′, dq)
  end
end
Adjust dq and find an unchecked neighbor J -cell jc′;
until there is no valid J -cell transition from jc;
continuity = false;
  return continuity, uv_{N} , jc_{N};
```

The process of Table II joint space search is made more efficient by allowing the search to continue in a direction, dq, instead of a random direction for each J-cell transition, thus narrowing the search space. If following a direction dq, the search reaches a joint configuration q that satisfies joint space task constraints, then dq is used again until the constraints are no longer satisfied. Once these constraints are no longer satisfied, dq is adjusted using the Jacobian matrix J(q) to identify the order of joint variable qᵢ which least affects the resulting change dx in the end-effector configuration. Starting with the least significant joint variable, the adjustment procedure generates a new value that is not previously used for that joint in dq, trying to obtain a new dq that is close to the previous dq in the hope of satisfying joint space task constraints with as little deviation from the original search direction as possible.

This process of Table I continues until every reachable uv-cell pair continuity is checked via a tree search and a uv space connectivity graph, G, is built based on neighboring feasibility continuity results. If the resulting graph is a single connected component, we determine that there is at least one end-effector path that can cover the surface S continuously while maintaining constraints. Upon determining the feasibility of a coverage pattern, the application 103 computes the coverage path for defining a continuous traversal of the surface of the task object relative to the uv coordinate set.

The worst case time complexity of the uv grid search depends on the worst case time complexity of the feasibility search between two adjacent uv-cells, which is essentially a depth-first search (DFS) in the joint space. The worst case time complexity of the DFS is O(b^{m}), where b is the maximum branching factor and m is the maximum depth of search. b≤3ⁿ−1, where n is the degrees of freedom of the manipulator. Usually, b<<3ⁿ−1 because (1) not all joints move during the transition from one uv-cell to an adjacent one, and (2) many joint configurations cause a violation of constraints. m depends on the joint limits and the value of δq. Essentially, if δq is used to discretize the high-dimensional joint space into a hyper-grid, m is bounded by the number of J-cells. Thus, the worst-case time complexity of the uv grid search algorithm is O(N·b^{m}), where N is the number of uv cells. The actual running time for feasibility check between two adjacent uv-cells takes just a few milliseconds.

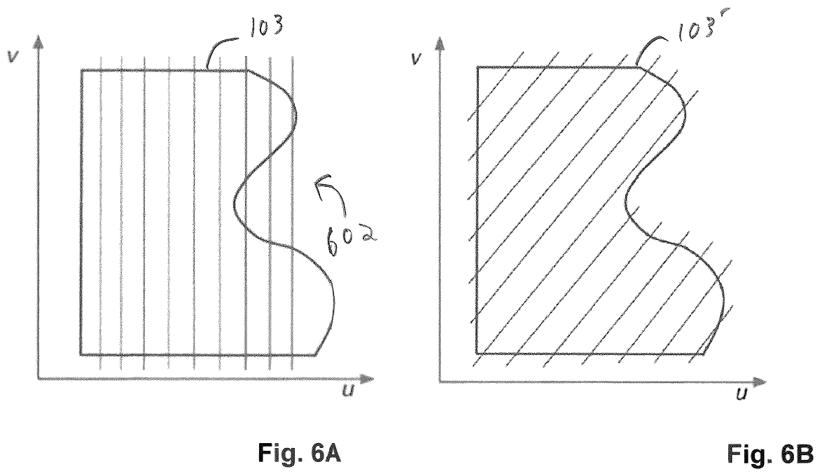

FIGS. 6A-6B show raster scan paths for providing the coverage path over the entire object. A convexity of a flattened (planar) uv space, as shown in FIG. 6, can be first used to decide whether a coverage pattern can be applied, since for some concave region, certain coverage patterns cannot provide uninterrupted coverage for the entire surface. If no coverage pattern can provide uninterrupted surface coverage, the surface can be decomposed into smaller and preferably convex regions so that each smaller region can be covered by a desired coverage pattern. Alternatively, other 2D CPP methods could be adapted to design a coverage pattern in the uv space. FIG. 6A depicts a scenario where the start direction failed a coverage check. FIG. 6B demonstrate a start direction that passes check on raster scan lines. It can be seen that the surface 103 has gaps when attempting to cover the concave region 602. Rotating the pattern about 45°, shown in FIG. 6B, results in raster scan lines that attain an unbroken traversal with no gaps. The application computes an initial curve including a set of points on the uv grid, and selects a raster pattern type for traversing the surface 103 relative to the initial curve, and computes the coverage path 150 by applying the selected raster pattern type to the surface at successive equidistant passes for attaining complete coverage of the surface.

A common raster pattern is a set of parallel, straight “scan” lines which are separated perpendicularly by a distance, ω, and connected at their ends in an alternating manner. We denote the direction of the lines as the start direction, which may include creating a raster pattern on the uv grid with a horizontal start direction. In general, we can determine if a start direction will result in a raster coverage pattern that covers the surface uninterrupted by using a systematic check on the scan lines. If each scan line intersects the surface boundaries only twice, then that start direction is suitable for the uv grid surface, as shown in FIG. 6B. If not, the start direction is rotated to a new direction, and the test is repeated. The lines are shortened to fit within the surface boundaries with end points connected in an alternating manner.

We denote UV as a coverage pattern on the uv grid with uv; being the i th uv point of the pattern such that UV=[uv₁, uv₂, . . . , uv_{M}]. Each uvᵢ indicates a center of a uv-cell; uvᵢ and uvᵢ₊₁ indicates centers of neighboring uv cells, for 1≤i<M. Note that the UV coverage pattern should only cross between uv-cells which are connected in the connectivity graph of the uv grid.

We denote H as the coverage pattern UV expressed in Cartesian coordinates, with hᵢ being the position of uv; on the pattern such that H=[h₁, h₂, . . . , h_{M}].

The application 130 must then perform singularity detection by computing whether a raster scan along the coverage path follows an unbroken continuous sequence along a uv coordinate set representing the surface. Let {R₁, R₂, . . . , R_{M}} denote a sequence of end-effector orientations, such that Rᵢ is the rotation matrix of the manipulator initialized with the end-effector's z-axis along the normal bᵢ of the triangle that contains the i th waypoint uv; of the coverage pattern. This is to best satisfy the orientation task constraint.

We compute the end-effector's position pᵢ corresponding to each waypoint uvᵢ with position hᵢ in the Cartesian space as:

$${p}_{i} = {h}_{i} - d \cdot {a}_{i} \qquad ( 17 )$$

where aᵢ is the third column of Rᵢ.

Now we initialize the end-effector coverage path P, s.t. P=[E₁, E₂, . . . , E_{M}], where Eᵢ, for i=1, . . . , M, is a homogeneous transformation matrix consisting of position pᵢ and rotation matrix Rᵢ. We denote Q as the sequence of corresponding joint states of P, with qᵢ being the i th joint state on the path such that Q=[q₁, q₂, . . . , q_{M}].

If a feasible coverage path exists (as determined above), it does not mean the generated initial path P is a feasible coverage path. The following subsections describe singularity detection on initial coverage path P, and if singularities are detected, how we alter path P to avoid singularities and best satisfy task constraints.

Even if the surface S is placed within the robot's workspace, depending on the shape and size of S, there can be internal singularities to prevent the manipulator from following the initial path. Two kinds of singularities have to be considered: joint space singularities and Cartesian space singularities.

We refer to joint space singularities along a joint space path as those configurations that exceed a certain joint limit, which result in failures of motion/trajectory planning. We refer to Cartesian space singularities along a Cartesian space path as those end-effector configurations that cannot be reached with the imposed task constraints.

The disclosed approach checks the end-effector path P for such singularities through the corresponding manipulator joint space path Q. Linear interpolation is performed between joint configurations qᵢ and qᵢ₊₁, for i=1, . . . , M, on path Q, such that:

$${q}_{{i}_{j}} = {q}_{i} + j \cdot ϵ \cdot ( {q}_{i + 1} - {q}_{i} ) , j = 1 , 2 , … \qquad ( 18 )$$

for a small ϵ. Forward kinematics yields corresponding Cartesian configurations. If the end-effector position pᵢ_{ⱼ} satisfies |pᵢ_{ⱼ}−pᵢ₊₁|>|pᵢ_{_{j−1}}−pᵢ₊₁, then a singularity occurs; otherwise, there is no singularity at pᵢ_{ⱼ}. The jointspace path between qᵢ and qᵢ₊₁ should result in end-effector positions where pᵢ_{ⱼ} is closer to pᵢ₊₁ than pᵢ_{_{j−1}}, otherwise a singularity exists between qᵢ and qᵢ₊₁.

It is preferable, if not mandatory, to avoid singularity. For every singularity encountered along the path (either a joint space singularity or a Cartesian space singularity), our planner alters the end-effector orientations in a neighborhood of the singularity configuration, called orientation smoothing, until a singularity free path is obtained.

For each singularity encountered along the end-effector initial coverage path P, say at the i th waypoint, our method re-orients the end-effector approach vector aᵢ₋ⱼ closer to that of the previous waypoint's approach vector a₍ᵢ₋ⱼ₎₋₁ with:

$${a}_{i - j} = \frac{{a}_{v}}{‖ {a}_{v} ‖} ,$$

where

$${a}_{v} = \frac{( {a}_{i - j} + {a}_{( i - j ) - 1} )}{2} ,$$

for j=0 to i−1. The path can be smoothed up to N times, where the difference between neighboring approach vectors are reduced to 2^{-N} original difference. Satisfaction of task constraints are checked after orientation smoothing at each point. The worst case time complexity for each smoothing processes is O(M) and the total algorithm execution time is proportional to how many singularities are detected along the initial coverage path P.

```
TABLE III
Initialize end-effector orientation sequence
{R₁, R₂, ..., R_{M} };
Initialize joint-space path Q = {q₁, q₂, ..., q_{M} };
i = 2; count = 0;
while i ≤M do
  check joint-space singularity and Cartesian-space singularity from qᵢ₋₁ to qᵢ:
  while Singularity at qᵢ₋₁ ≤q* ≤qᵢ and count < K do
    for j = 0 to i − 1 do
    smooth the orientation Rᵢ₋ⱼ if needed to reduce the difference to the
    orientation R₍ᵢ₋ⱼ₎₋₁ while satisfying the orientation constraint and update
    pᵢ₋ⱼ accordingly to satisfy position constraint;
    update qᵢ₋ⱼ based on the updated pᵢ₋ⱼ;
    end
    count++;
  end
  if no singularity then
    i++;
  else
    exit with ”no feasible solution”;
  end
end
output Q;
```

The complete manipulator path planner is shown in Table III, which alters the initial manipulator path to create a singularity free path, satisfying equality task constraints, and best satisfying inequality task constraints. If it is not possible to create such a path under the current coverage pattern, the planner returns “no feasible solution”. Another coverage pattern can be tried.

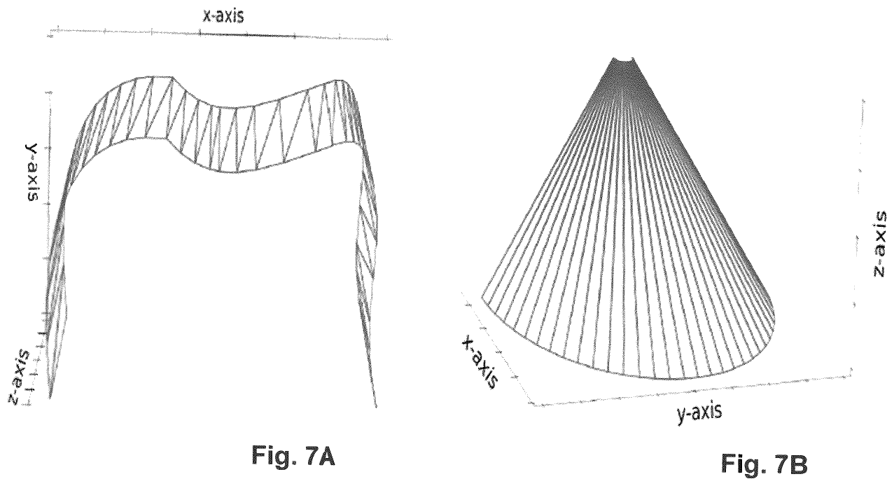

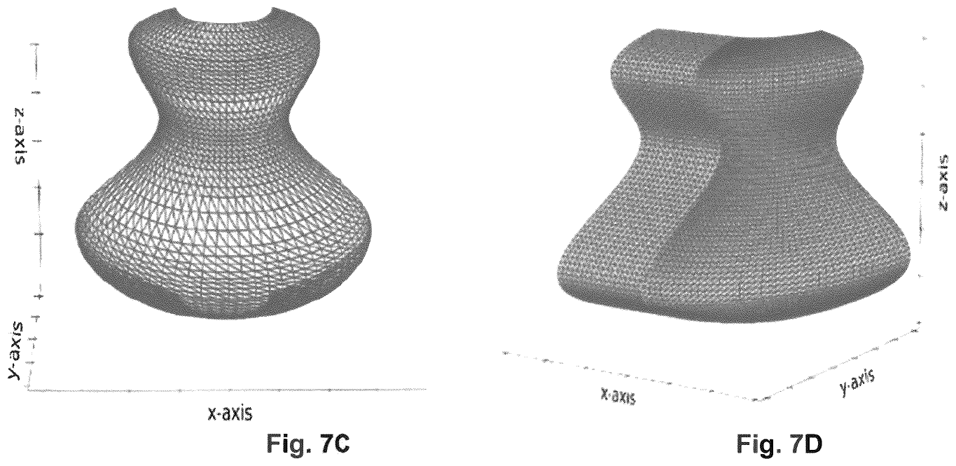

FIGS. 7A-7D shows a polygon mesh rendering of the received input representation of the task object. To test the approach, Solidworks® was invoked to generate a polygon mesh of a Curvy (SoT), Cone (SoR), Vase (SoR), and Corner (SoTR) surface (see FIG. 7), containing 68, 32, 3743, and 9200 triangle faces respectively. A manipulator was employed which contains seven revolute joints, with the joint vector q=[θ₁, θ₂, . . . , θ₇]^{T} and link parameters I=[d₁, d₃, a₄, a₅, d₅, a₇]=[0.3,0.3,0.08,−0.08,0.3,0.08](m).

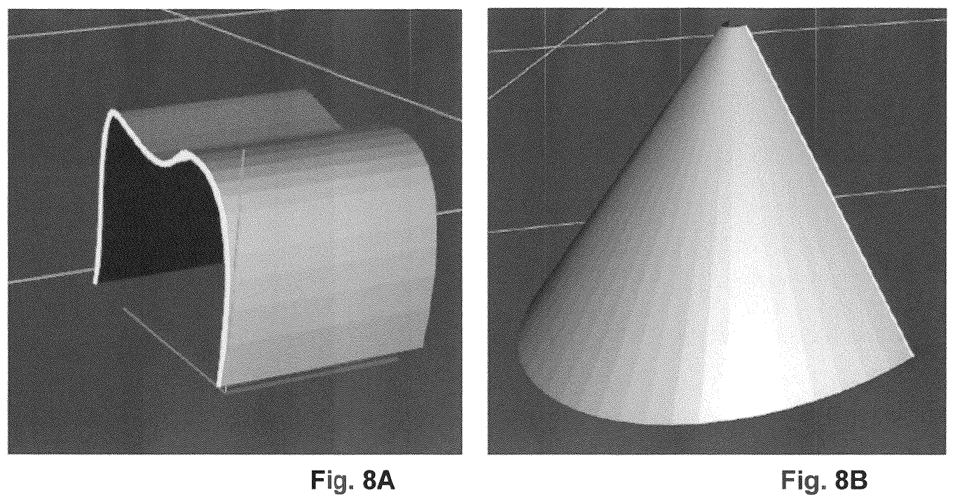

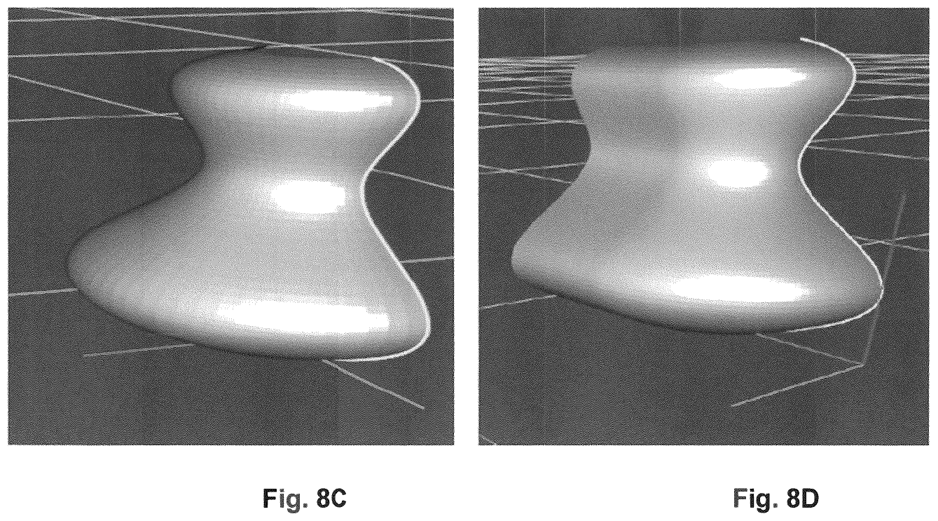

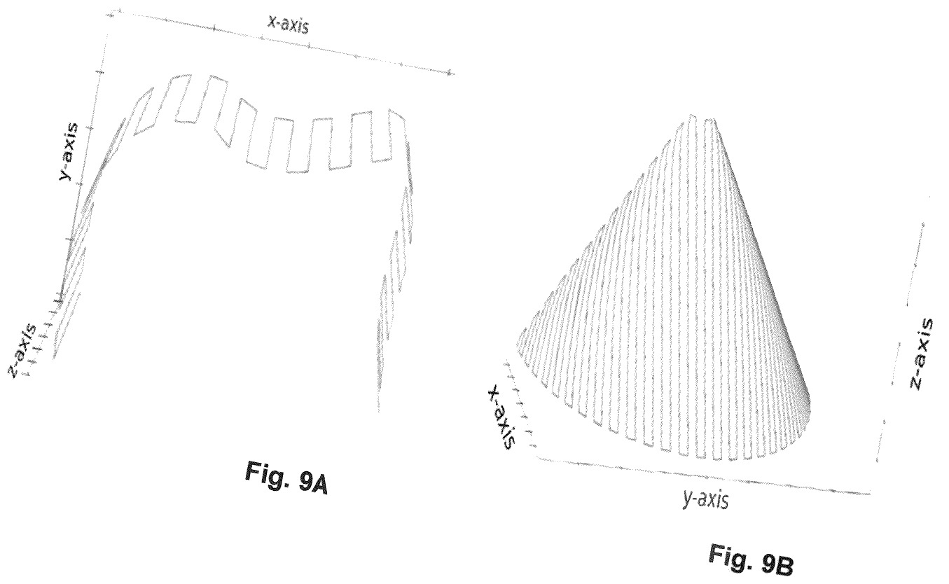

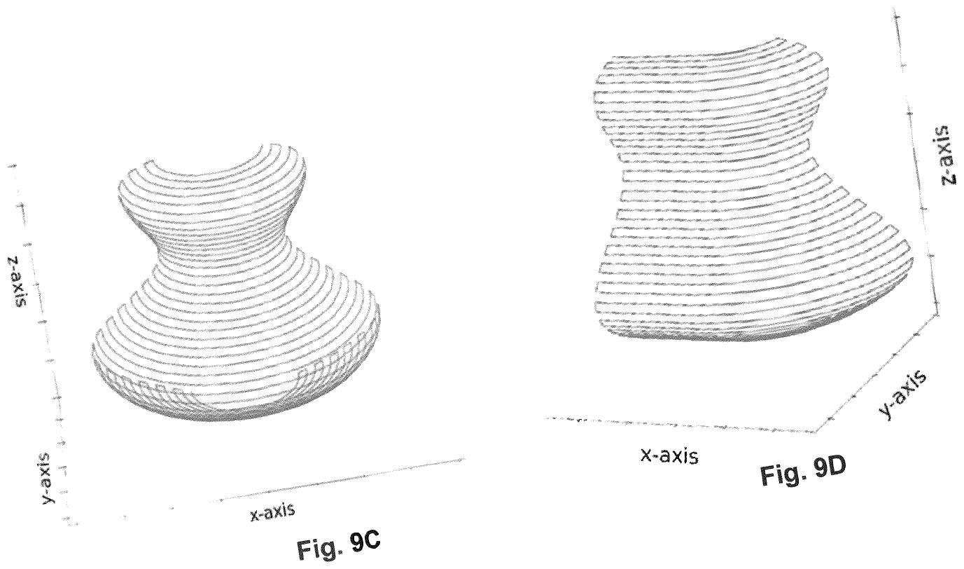

FIGS. 8A-8D show an initial curve 301 for the uv grid space representation of the respective objects of FIGS. 7A-7D. FIGS. 8A-8D are the results of interactive placement of the surface frame and determination of the C curve in the virtual environment. An alternate view would give a flattened view of the resulting uv grid for each surface. The resulting initial coverage paths are shown in FIGS. 9A-9D.

FIGS. 9A-9D show a coverage path computed on the uv grid for the respective objects from FIGS. 7A-7D and 8A-8D. The application 130 computes a plurality of coverage regions on the surface, selecting the raster pattern for each coverage region; and computing a transition path between the coverage region, to achieve full coverage of the surface 103 in a consistent pass, meaning without “lifting” the end effector (manipulator), for consistently delivering the paint, welding bead, or the like emanating from the end effector.

FIG. 9B, in particular, shows the results of a coverage pattern that was generated on a cone surface using our method. This pattern is not trivial to generate using other methods but is easily generated and evenly spaced using our uv grid. The “vertical” raster pattern is straight near the center yet spiral on either side. This is a simple example to demonstrate that using the uv grid generated by our method, non-trivial coverage patterns can be produced on 3D freeform surfaces.

FIGS. 7A-9D show the progression for each (A-D) shape. This includes flattening the uv space and used straightline axes to represent u and v to produce the 2D view. Note that this 2 D view results in some distortion of the polygon meshes, which do not exist in the 3D surface. This seamless representation of the surface uv space enables the use of common 2D coverage patterns on it.

Other suitable 2D coverage patterns can be applied depending on the resulting uv grid to cover the surface. It is significant that generation of the uv grid allows evenly spaced application of (different) coverage patterns. A coverage path at turns of a coverage pattern can be further smoothed by interpolating between adjacent uv-cells in the initial coverage pattern.

To produce a smooth coverage along a uniform coverage pattern on the surface S, the corresponding end-effector path P has non-uniform transitions from one configuration to the next. This is a result of Eq. (17), which relates the position and orientation constraints, such as the end-effector's position offset from the surface is along its approach direction. This is important to produce a smooth and uniform surface coverage

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. In a robotic environment having a task object represented by a 3D surface, a method for planning a coverage path, comprising:
receiving a representation of the task object in a 3-dimensional coordinate system, the task object defined by a surface;
evaluating the task object for determining a feasibility of a coverage pattern, the coverage pattern defining a continuous traversal of the surface; and
computing a coverage path for traversing the surface according to the coverage pattern, the coverage path defined by a uv coordinate set representing the surface.

2. The method of claim 1 further comprising receiving the task object as a wireframe representation of triangles defined by nodes and vertices in a 3-dimensional cartesian system.

3. The method of claim 1 wherein determination of the feasibility further comprises:
identifying task constraints, the task constraints based on kinematics of a robot for movement along an entirety of the uv coordinate system representing the surface of the task object; and
identifying manipulator constraints, the manipulator constraints indicative of a manipulator coupled to the robot attaining placement within a predetermined offset distance of the surface of the task object.

4. The method of claim 1 further comprising
computing a uv grid on the surface from the representation of the task object, the representation being a 3-dimensional free form surface and the uv grid defining the surface of the task object.

5. The method of claim 4 wherein computing the uv grid further comprises:
receiving the representation as a 3-dimensional polygon mesh defining a non-intersecting free form surface;
locating an axis and a curve on the free form surface, and performing at least one of:
i: computing a surface of translation based on a translation of the curve along the axis
ii: computing a surface of rotation based on a rotation around the axis; and
iii: computing a surface of translation and rotation from the curve such that rotations along the surface are parallel to the axis and translations of the curve are on a plane normal to the axis.

6. The method of claim 1 further comprising, upon determining the feasibility of a coverage pattern, computing the coverage path for defining a continuous traversal of the surface of the task object relative to the uv coordinate set.

7. The method of claim 1 further comprising performing a singularity detection by computing whether a raster scan along the coverage path follows an unbroken continuous sequence along a uv coordinate set representing the surface.

8. The method of claim 1 wherein the coverage path defines an even discretization of points on the uv grid defining the surface.

9. The method of claim 4 further comprising:
computing an initial curve including a set of points on the uv grid;
selecting a raster pattern type for traversing the surface relative to the initial curve; and
computing the coverage path by applying the selected raster pattern type to the surface at successive equidistant passes for attaining complete coverage of the surface.

10. The method of claim 9 further comprising:
computing a plurality of coverage regions on the surface;
selecting the raster pattern for each coverage region; and
computing a transition path between the coverage region.

11. In a robotic environment having a task object represented by a 3D surface, a system for planning a coverage path, comprising:
an interface for receiving a representation of the task object in a 3-dimensional coordinate system, the task object defined by a surface;
a server having an application and processor for evaluating the task object for determining a feasibility of a coverage pattern, the coverage pattern defining a continuous traversal of the surface; and
a rendering device for outputting a computed coverage path for traversing the surface according to the coverage pattern, the coverage path defined by a uv coordinate set representing the surface.

12. The system of claim 11 wherein the interface is configured for receiving the task object as a wireframe representation of triangles defined by nodes and vertices in a 3 dimensional cartesian system.

13. The system of claim 12 wherein the application is further configured for computing a uv grid on the surface from the representation of the task object, the representation being a 3 dimensional free form surface and the uv grid defining the surface of the task object.

14. A computer program embodying program code on a non-transitory computer readable storage medium that, when executed by a processor, performs steps for implementing a method for planning a robotic coverage path over a task object, the method comprising:
receiving a representation of the task object in a 3-dimensional coordinate system, the task object defined by a surface;
evaluating the task object for determining a feasibility of a coverage pattern, the coverage pattern defining a continuous traversal of the surface; and
computing a coverage path for traversing the surface according to the coverage pattern, the coverage path defined by a uv coordinate set representing the surface.

15. The program code of claim 14, wherein the method further comprises receiving the task object as a wireframe representation of triangles defined by nodes and vertices in a 3 dimensional cartesian system.

16. The program code of claim 14, wherein determination of the feasibility further comprises:
identifying task constraints, the task constraints based on kinematics of a robot for movement along an entirety of the uv coordinate system representing the surface of the task object; and
identifying manipulator constraints, the manipulator constraints indicative of a manipulator coupled to the robot attaining placement within a predetermined offset distance of the surface of the task object.

17. The program code of claim 14, wherein the method further comprises
computing a uv grid on the surface from the representation of the task object, the representation being a 3 dimensional free form surface and the uv grid defining the surface of the task object.
